(19) United States
(12) Patent Application Publication
(10) Pub. No.: US 2020/0001588 A1
(43) Pub. Date: Jan. 2, 2020

(54) METHOD AND APPARATUS FOR PRODUCING AN ANTIMICROBIAL COATING

(71) Applicant: Casey Wright, Gardena, CA (US)

(72) Inventor: Casey Wright, Gardena, CA (US)

(21) Appl. No.: 16/019,668

(22) Filed: Jun. 27, 2018

(51) Int. Cl. B32B 38/00; B32B 5/02; B32B 5/24; B32B 37/18

(52) U.S. Cl. CPC B32B 38/00; B32B 5/028; B32B 5/245; B32B 2437/04; B32B 2262/0276; B32B 2038/0052; B32B 37/18

(57) ABSTRACT

A device for producing an antimicrobial coating on a surface of an object is provided. The device may include: one or more microfiber layers having one or more polyester layers and one or more foam layers; one or more mesh spacers to regulate air between the polyester layers and the foam layers; and an antimicrobial application unit for applying one or more antimicrobial coatings on the surface of the object.

### CROSS-REFERENCES TO RELATED APPLICATIONS

N/A.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD OF THE TECHNOLOGY

The present disclosure generally relates to the field of antimicrobial coatings and, more specifically, to a method and an apparatus for applying antimicrobial coating.

### DESCRIPTION OF THE RELATED ART

Over the years, several solutions have been proposed to reduce the buildup of bacteria and/or microbes that can cause disease, fungus, mold, viruses, infection and/or irritation. However, the cost to implement and improve these designs have come with many shortcomings and led to inferior solutions in the market and the need to provide more desirable solutions.

Further, businesses that produce alternatives to previous solutions often charge more in excess than what the public is willing to pay for. A simple, affordable solution is still sought with a more achievable containment reduction efficacy than what the market currently offers.

Therefore, what is needed is a method and an apparatus for producing an antimicrobial coating with improved buildup reduction contaminant efficacy.

### SUMMARY

In an embodiment, a device for producing an antimicrobial coating on a surface of an object is provided. The device may include: one or more microfiber layers having one or more polyester layers and one or more foam layers; one or more mesh spacers to regulate air between the polyester layers and the foam layers; and an antimicrobial application unit for applying one or more antimicrobial coatings on the surface of the object.

In another embodiment, an apparatus for producing an antimicrobial coating on a surface of an object is provided. The device may include: one or more microfiber layers having one or more polyester layers and one or more foam layers; one or more mesh spacers to regulate air between the polyester layers and the foam layers; and an antimicrobial application unit for applying one or more antimicrobial coatings on the surface of the object.

In yet another embodiment, a method for producing an antimicrobial coating on a surface of an object is provided. The method includes: applying one or more polyester layers to a surface of an object; applying one or more foam layers to the surface of the object; joining the polyester layers with the foam layers; and applying one or more antibacterial coatings to the surface of the object.

In still another embodiment, a means for producing an antimicrobial coating on a surface of an object is provided. The means may include: means for applying one or more polyester layers to a surface of an object; means for applying one or more foam layers to the surface of the object; means for joining the polyester layers with the foam layers; and means for applying one or more antibacterial coatings to the surface of the object.

### BRIEF DESCRIPTION OF THE DRAWINGS

The present invention is described in detail below with reference to the attached drawing figures, which are incorporated by reference herein and wherein:

FIG. 1 is a block diagram illustrating an exemplary embodiment of the invention;

FIG. 2 is a block diagram of a computer that may be connected to the network;

FIG. 3 is a block diagram in accordance with another exemplary embodiment of the invention;

FIG. 4 is a diagram with a cap in accordance with another exemplary embodiment of the invention; and

FIG. 5 is a flowchart illustrating a process in accordance with exemplary embodiments of the invention.

### DETAILED DESCRIPTIONS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent application, which would still fall within the scope of the claims.

It should also be understood that, unless a term is expressly defined in this patent using the sentence “As used herein, the term ‘ ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent application (other than the language of the claims). To the extent that any term recited in the claims at the end of this patent application is referred to in this patent application in a manner consistent with a single meaning, that is done for sake of clarity only so as to not confuse the reader, and it is not intended that such claim term by limited, by implication or otherwise, to that single meaning Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the exemplary embodiments of the invention, further discussion of such software and ICs, if any, will be limited to the essentials with respect to the principles and concepts of the preferred embodiments.

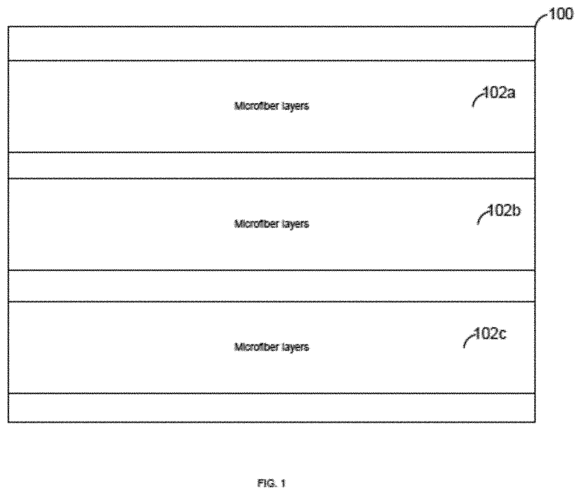

FIG. 1 illustrates a block diagram 100 in accordance with an exemplary embodiment of the invention. As shown in FIG. 1, the device 100 may be made of one or more microfiber layers 102(a-c). The microfiber layers 102 (a-c) may be implemented in inside or outside of apparel, headwear, home décor, furniture, pet items, auto interior, sleeping bags, sports equipment, shoes, gloves. The microfiber layers 102 (a-c) may comprise a material composition in the range from 0% to 100% of the pressed and/or molded materials (not shown). In an optimal embodiment, the microfiber layers 102 (a-c) may comprise a material composition of at most 50% polyester, at most 20% wool, and at most 30% nylon. The microfiber layers 102 (a-c) may have a thickness in the range of 0.001 inches to 100 inches. In an optimal embodiment, the thickness of the microfiber layers 102 (a-c) is in the range of 0.002 to 0.004 inches.

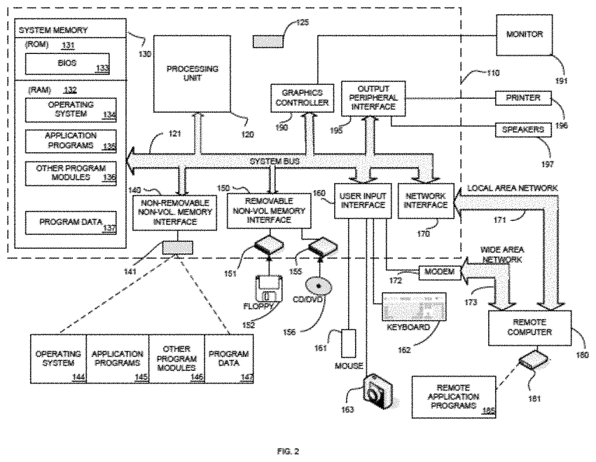

FIG. 2 illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 may also include a cryptographic unit 125. Briefly, the cryptographic unit has a calculation function that may be used to verify digital signatures, calculate hashes, digitally sign hash values, and encrypt or decrypt data. The cryptographic unit 125 may also have a protected or secure memory for storing keys and other secret data. In addition, the cryptographic unit 125 may include an RNG (random number generator) which is used to provide random numbers. In other embodiments, the functions of the cryptographic unit 125 may be instantiated in software or firmware and may run via the operating system or on a device.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. A camera 163, such as web camera (webcam), may capture and input pictures of an environment associated with the computer 110, such as providing pictures of users. The webcam 163 may capture pictures on demand, for example, when instructed by a user, or may take pictures periodically under the control of the computer 110. Other input devices (not shown) may include a microphone, joystick, game pad, satellite dish, scanner, or the like. These and other input devices are often connected to the processing unit 120 through an input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181.

The communications connections 170-172 allow the device to communicate with other devices. The communications connections 170-172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

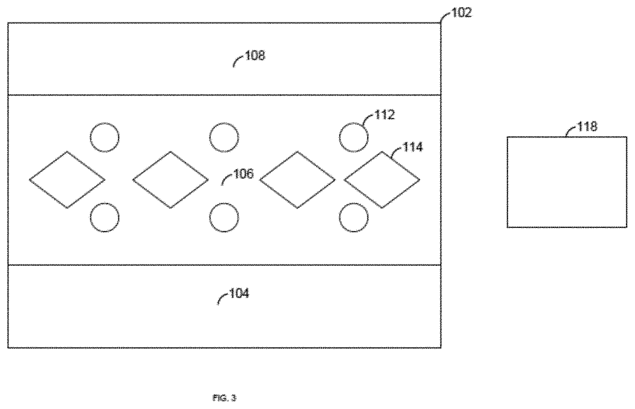

FIG. 3 illustrates a block diagram 102 in accordance with an exemplary embodiment of the invention. As shown in FIG. 3, the microfiber layers 102 may include one or more polyester layers 104, one or more polyester foam and mesh layers 106, and one or more antimicrobial coatings 108. In some implementations, an antimicrobial application unit 118 may be used for applying one or more antimicrobial coatings 108 to a surface of the object. In another embodiment, the antimicrobial coatings 108 may include one or more antibacterial coatings, surfaces, finishes, or layers.

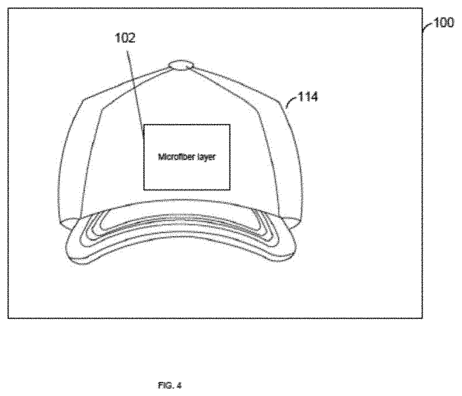

FIG. 4 illustrates a diagram 100 with a cap in accordance with an exemplary embodiment of the invention. As shown in FIG. 4, the device 100 can be implemented as a cap 116 is an exemplary embodiment. The cap 116 may include microfiber layers 102 on the surface of the cap 116 or inside the cap 116 (not shown).

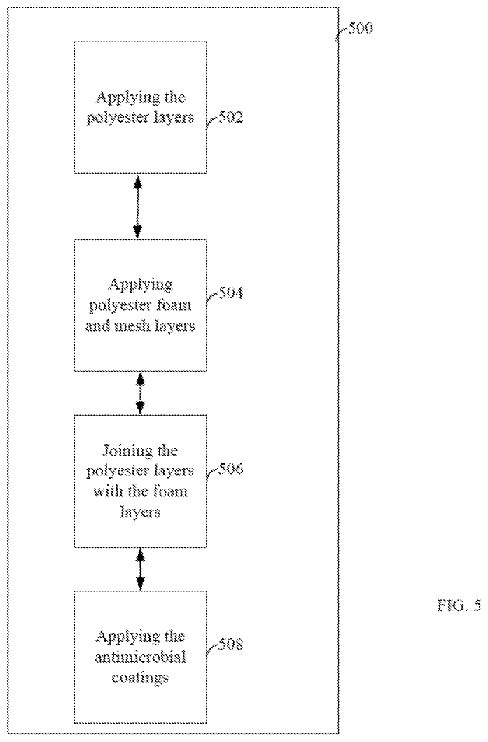

FIG. 5 illustrates a flowchart describing a process 500 in accordance with exemplary embodiments of the invention. At block 502, one or more polyester layers are applied to a surface of an object. At block 504, one or more polyester foam and mesh layers are applied to the surface of the object. At block 506, the polyester layers and polyester foam and mesh layers are joined. At block 508, one or more antibacterial coatings are applied to the surface of the object.

In another embodiment, the polyester layers 104 may include one or more of the following pressed and/or molded materials: leather, wool, neoprene, suede, foam, mesh, vinyl, nylon, polyester, or any known material known by those skilled in the art. The polyester layers 104 may comprise a material composition in the range from 0% to 100% of the pressed and/or molded materials. In an optimal embodiment, the polyester layers 104 may comprise a material composition of at most 50% polyester, at most 20% wool, and at most 30% nylon. The polyester layers 104 may have a thickness in the range of 0.001 inches to 100 inches. In an optimal embodiment, the thickness of the polyester layers 104 is in the range of 0.002 to 0.004 inches.

In another embodiment, the polyester foam and mesh layers 106 may include one or more of the following pressed and/or molded materials. The polyester foam and mesh layers 106 may comprise a material composition in the range from 0% to 100% of the pressed and/or molded materials. In an optimal embodiment, the polyester foam and mesh materials may comprise a material composition of at most 50% polyester, at most 30% mesh, and at most 20% foam. In some embodiments, the polyester foam and mesh layers 106 may have a thickness in the range of 0.001 inches to 100 inches. In an optimal embodiment, the thickness of the polyester foam and mesh layers 106 is in the range of 0.002 to 0.004 inches.

In another embodiment, the polyester foam and mesh layers 106 may include one or more polyester blend mesh spacers (not shown) to regulate air and/or heat flow between the polyester layers 104 and polyester foam and mesh layers 106 by reducing and/or trapping heat. In some embodiments, the polyester blend mesh spacers may have a thickness in the range of 0.001 inches to 100 inches. In optimal embodiment, the thickness of the polyester blend mesh spacers may be in the range of 0.001-0.5 inches.

In some embodiments, the antimicrobial coatings 108 may be applied to one or more sides, one or more surfaces, and/or one or more layers of a fabric, item, or component. In some implementations, the application amount may be in the range of in the range from 0% to 100% of the antimicrobial coatings 108. In an optimal embodiment, the antimicrobial coatings 108 may be applied at a concentration of at least 30%. In another embodiment, the antimicrobial coatings may reduce the buildup of bacteria and/or microbes that can cause disease, fungus, mold, viruses, infection and irritation at a rate of 1%-99% efficacy. In an optimal embodiment, the buildup reduction may be at least 10%.

In yet another embodiment, the polyester foam and mesh layers 106 may include one or more resilient foam materials. The resilient foam materials (not shown) may be made of one or more of the following pressed and/or molded materials. The resilient foam materials may comprise a material composition in the range from 0% to 100% of any the one or more pressed and/or molded materials. In an optimal embodiment, the resilient foam materials may comprise a material composition of at most 50% polyester, at most 20% wool, and at most 30% nylon. In some embodiments, the resilient foam materials may include one or more foam units 112 and one or more mesh units 114. The foam units 112 and mesh unit 114 may include one or more mesh frames, mesh layers, shock absorbing layers, moisture absorbing layers, spring layers or any structural elements known to those skilled in the art.

In an embodiment, the device 100 may be implemented using microfiber layers 102 with, or without, one or more polyester foam layers and/or one or more polyester mesh layers. In some embodiments, the microfiber layers 102 may be one or more microfiber brushed polyester knit fabric layers. In other embodiments, the polyester blend mesh spacers may include one or more charcoal foam polyester spacer material layers with one or more polyester mesh backing layers with one or more antimicrobial coatings.

In another embodiment, the microfiber brushed polyester knit fabric layers with an antimicrobial finish may be, directly or indirectly, fused, bonded, or affixed to the charcoal foam polyester spacer material layer with, or without, a polyester mesh backing that includes one or more antimicrobial coatings. In some embodiments, the microfiber layer may be, directly or indirect, contact with a skin surface of a user or one or more layers of the antimicrobial coatings.

In yet another embodiment, the polyester layers 104 and the polyester foam and mesh layers 106 may combined together using the following processes: laminated, flame laminated, or adhesively laminated, or any known surface adhesive process known by those skilled in the art.

In still another embodiment, the flame laminating may be used for creating single-sided, double-sided, or multilayer laminations measuring up to 0.75 inches for an optimal thickness. In yet another embodiment, the flame lamination process may involve passing foam (and flame laminable grades of other materials) over an open flame, which creates a thin, tacky layer of melted polymer on the foam surface. As a result, a strong bond may form between the foam and the substrate when secondary material is quickly brought into contact with the tacky surface under controlled tension and pressure.

In another embodiment, the wet adhesive lamination process may be used. In some embodiments, the bonding agent may be in a liquid state when the webs are joined together. In an alternate embodiment, the dry lamination process may be used. In some embodiments, the bonding agent may be dissolved into a liquid (water or a solvent), is applied to one of the webs, before being evaporated in the drying oven. The adhesive coated web may be laminated to the other under strong pressure and using heated rollers, which can improve the bond strength of the laminate.

In other embodiments, the dry adhesive lamination process may be used. In some embodiments, the bonding agent may be dissolved into a liquid (water or a solvent), is applied to one of the webs, before being evaporated in the drying oven. The adhesive coated web can be laminated to the other under strong pressure and using heated rollers, which can improve the bond strength of the laminate.

In some implementations, the type and chemicals of antimicrobial/antibacterial may include inorganic chemicals and/or metal compounds: silver zeolite, titan oxide, silver silicate, soluble glass powder with metallic ions, silver sulphonate, iron-phtalozyanat, copper sulphonate, tenside: organic silicon with tertiary ammonium salts, pheonol: biozol, thimol, alkylenbisphenol, sodium salt, Anilin^{.} 3,4,4-trichlorocarbanilin, natural products: chitosan, and use non-leaching type.

In yet another embodiment, these antimicrobials may be bound to the fabric do not migrate off but may destroy the bacteria coming in contact with the surface of fabric. The chemical be attached to the substrate either by chemical bonding or by polymerizing, forming a layer on the surface of treated fabric. The microbes may not consume the chemical, instead, the chemical acts on the cell membrane of the microbes. As a result, the finishing may be permanent and may remain effective for substantial length of time. The finish may be withstood for more than 40 laundry washes.

In still another embodiment, applications of antimicrobial finishing activity may include: the chemical which is used as an antimicrobial activity, applied to the fabric material by exhaust, pad-dry-cure, coating, spray and foam techniques.

In another embodiment, the substances can also be applied by directly adding into the fiber spinning dope. Various methods for improving the permanence of the finish such as: insolubilisation of the capable substances in/on the fiber; apply the resin on the fiber and improve the adhesion by cross linking agents; with the help of microbial agents protect the fiber matrix by micro covering; application of finish on the fiber surface; modifying the chemical structure of the fiber by forming the covalent bond; and application of nano polymers, homo polymers and/or copolymer on to substrate.

In some embodiments, the device 100 may be implemented as the following: hat sweatbands, headbands, bandannas, beanies, shirts, jackets, underwear, pants, socks, gloves, scarfs, shoes, uniforms, scrubs, robes, aprons, baby body suit/onesie, baby bib, back pack, hand bag, bra, jock strap, sheets, towels, pillow cases, rugs, blankets, car seat cover, motorcycle seat cover, furniture cover, yoga mat, baseball glove, boxing glove, glove, helmet, headwear, rock climbing shoes, sports tights, animal collar, animal bed, dry suit, race suit, space suit, sandals, transportation interior, sleeping bag, toilet seat cover, etc.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

What is claimed is:

1. A device for producing an antimicrobial coating on a surface of an object comprising:
one or more microfiber layers having one or more polyester layers and one or more foam layers;
one or more mesh spacers to regulate air between the polyester layers and the foam layers;
and an antimicrobial application unit for applying one or more antimicrobial coatings on the surface of the object.

2. The device of claim 1, wherein the foam layers include mesh layers.

3. The device of claim 1, wherein the device is a cap.

4. The device of claim 1, wherein the mesh spacers are polyester blend mesh spacers.

5. The device of claim 1, wherein the mesh spacers include one or more charcoal foam material layers.

6. The device of claim 1, wherein the mesh spacers include one or more mesh backing layers.

7. The device of claim 1, wherein the antimicrobial coatings is applied at a concentration of at least 10%.

8. The device of claim 1, wherein the antimicrobial coatings is applied at a concentration of at least 20%.

9. An apparatus for producing an antimicrobial coating on a surface of an object comprising:
one or more microfiber layers having one or more polyester layers and one or more foam layers;
one or more mesh spacers to regulate air between the polyester layers and the foam layers;
and an antimicrobial application unit for applying one or more antimicrobial coatings on the surface of the object.

10. The apparatus of claim 9, wherein the foam layers include mesh layers.

11. The apparatus of claim 9, wherein the device is a cap.

12. The apparatus of claim 9, wherein the mesh spacers are polyester blend mesh spacers.

13. The apparatus of claim 9, wherein the mesh spacers include one or more charcoal foam material layers.

14. The apparatus of claim 9, wherein the mesh spacers include one or more mesh backing layers.

15. A method for producing an antimicrobial coating on a surface of an object comprising:
applying one or more polyester layers to a surface of an object;
applying one or more foam layers to the surface of the object;
joining the polyester layers with the foam layers;
and applying one or more antibacterial coatings to the surface of the object.

16. The method of claim 15, wherein the foam layers include mesh layers.

17. The method of claim 15, wherein the mesh spacers are polyester blend mesh spacers.

18. The method of claim 15, wherein the mesh spacers include one or more charcoal foam material layers.

19. The method of claim 15, wherein the mesh spacers include one or more mesh backing layers.

20. The method of claim 15, wherein the antimicrobial coatings is applied at a concentration of at least 10%.
